(19) United States
(12) Patent Application Publication
(10) Pub. No.: US 2014/0119609 A1
(43) Pub. Date: May 1, 2014

(54) IMAGE RECOGNIZING APPARATUS AND METHOD

(71) Applicant: ELECTRONICS AND TELECOMMUNICATIONS RESEARCH INSTITUTE, Daejeon (KR)

(72) Inventors: Jae-Yeong LEE, Daejeon (KR); Wonpil YU, Daejeon (KR)

(73) Assignee: ELECTRONICS AND TELECOMMUNICATIONS RESEARCH INSTITUTE, Daejeon (KR)

(21) Appl. No.: 13/892,872

(22) Filed: May 13, 2013

(30) Foreign Application Priority Data
Oct. 31, 2012 (KR) 10-2012-0122555

(51) Int. Cl. G06K 9/62

(52) U.S. Cl. CPC G06K 9/6215
USPC 382/106

(57) ABSTRACT

An image recognizing apparatus includes a sample image acquiring unit configured to acquire a sample image having one or more target objects therein from a camera; and a reference range setting unit configured to calculate image locations and image heights for the respective target objects from the sample image and set a reference range of the image heights depending on the image positions. Further, the image recognizing apparatus includes a selection unit configured to determine whether a candidate area of each target object in the sample image acquired by the camera falls within the reference range to select an effective candidate area.

### CROSS-REFERENCE TO RELATED APPLICATION(S)

The present invention claims priority of Korean Patent Application No. 10-2012-0122555, filed on Oct. 31, 2012, which is incorporated herein by reference.

### FIELD OF THE INVENTION

The present invention relates to an image recognizing apparatus and method; and more particularly, to an image recognizing apparatus and method, which detects the effective size of a target object on the ground and removes an unnecessary candidate area, thereby improving an image processing speed thereof.

### BACKGROUND OF THE INVENTION

In recent, there has increased an application field and importance on a technique to recognize images. For example, a black-box system, which recognizes and records images captured through a camera mounted on a vehicle, detects pedestrians and other vehicles around the vehicle to call a driver's attention. Therefore, the black-box system is often used as a security assistant device so that the driver can securely drive a car.

In general, an image recognizing system finds out the positions and sizes for all the target subjects in the image to detect the presence of any target objects in the image. However, such a recognition scheme has problems that it takes a long time to search for the target objects, and it has a high probability to make a false detection. In order to solve the above problems, there has developed a scheme to detect the presence of the target objects by defining a search space within the image based on the geometrical relationship between the camera and the ground.

For example, a fixed CCTV camera attached on a structure such as a building, a camera fixedly attached to a movable vehicle and robot, and the like have an unchanged position with respect to the ground. This makes it possible to establish a geometrical relationship between the ground and the camera with variables such as height, pan, tile and the like. A conventional image recognizing apparatus exploits the geometrical relationship to detect abnormal candidate areas before recognizing the target objects. For example, as shown in FIG. 1, in a case where the image recognizing apparatus recognizes pedestrians using a black-box camera mounted in a vehicle, the image recognition apparatus determines the candidate areas which float on a space, and are too tall or small and the like as the abnormal candidate areas ‘A’ of the pedestrian. The image recognizing apparatus then skips over the abnormal candidate areas ‘A’ and tries to recognize only normal candidate areas ‘B’, resulting in reducing both the search time and false detections.

More specifically, the conventional image recognizing apparatus uses a homography transform matrix H between the ground and the image plane of the camera to represent the relationship between the ground plane and a camera. The homography transformation matrix H enables the linear transformation between image pixel coordinates (px, py) and ground coordinates (lₓ, l_{y}). This transformation matrix H is represented by a 3×3 matrix as in Equation 1.

$$[ \begin{matrix}{l}_{X} \\ {l}_{Y} \\ 1\end{matrix} ] = H [ \begin{matrix}px \\ py \\ 1\end{matrix} ] , \\ H = [ \begin{matrix}{h}_{00} & {h}_{001} & {h}_{02} \\ {h}_{10} & {h}_{11} & {h}_{12} \\ {h}_{20} & {h}_{21} & {h}_{22}\end{matrix} ] \qquad [ Equation 1 ]$$

For example, as shown in FIG. 2, the image recognizing apparatus detects a candidate area ‘C’ of a pedestrian at an image pixel coordinate system and obtains a ground coordinate (lₓ, l_{y}) at a physical coordinate system from the image pixel coordinate (px, py) at a bottom line of the candidate area ‘C’, e.g., at the center of a tiptoe of the pedestrian, using Equation 1. Further, the image recognizing apparatus calculates a physical distance of the candidate area ‘C’ and a height or stature of the pedestrian on the ground using the focal length of the camera and the pixel height of the candidate area ‘C’. As such, only when the physical distance of the candidate area ‘C’ and the height or stature of the pedestrian in the image fall within a normal range, the image recognizing apparatus tries to recognize the candidate area ‘C’, reducing the search time and the probability of false detection.

As described above, conventional image recognizing apparatus employs a method to confine the search region using the homography matrix H. However, calculating the homography matrix H and the focal length of the camera requires the use of additional tools and associated background knowledge on camera calibration, which leads to a long development time. Further, the method to confine the search region using the homography matrix H is not applicable depending on circumstances.

Further, the method of utilizing the homography matrix H has a limitation in reflecting the size deviation of the target object and the recognition error of the vision-based recognition system effectively. For example, in a case where the target object is located far away from the camera, one pixel difference in number in an image may come to several to several tens meters in physical distance. Meanwhile, in a case where the target object is located in a short distance from the camera, although there is several tens pixel difference in number in the image, the physical distance may actually be almost no difference.

Therefore, if the allowable range of stature of pedestrian is set between 1 meter to 2 meter, it will be too restrictive to detect pedestrians far away from the camera because several pixels of error in homography will falsely reject true candidate regions. On the contrary, if the detection range is set wide in order to cope with homography error, it will be too loose for close pedestrians. Thus, it is difficult to control the search space effectively by using homography.

### SUMMARY OF THE INVENTION

In view of the above, the present invention provides an image recognizing apparatus and method, which is capable of detecting the effective size of target objects in each image location and removing unpromising or abnormal candidate areas regardless of the distance between the camera and the target objects, thereby requiring no complex camera calibration procedure for confining a search region reduce the image processing time required for the detection of the target objects.

In accordance with a first aspect of the present invention, there is provided an image recognizing apparatus including: a sample image acquiring unit configured to acquire a sample image having one or more target objects therein from a camera; a reference range setting unit configured to calculate image locations and image heights for the respective target objects from the sample image and set a reference range of the image heights depending on the image positions; and a selection unit configured to determine whether a candidate area of each target object in the sample image acquired by the camera falls within the reference range to select an effective candidate area.

Further, the sample image acquiring unit may acquire a plurality of sample images depending on the distance between the camera and the respective target objects.

Further, the reference range setting unit may make a graph of the image heights of the target objects depending on the image positions of the target objects and may approximate the upper bound and the lower bound of the image heights on the graph depending on the image locations in a pair of straight lines.

Further, the reference range may be the range between the lower bound and the upper bound.

Further, the upper bound and the lower bound of the image heights for each image location may be set by a user.

Further, the image recognizing apparatus may further comprise an image recognition unit configured to recognize the target object in the effective candidate area.

Further, the camera may be placed in a fixed location spaced apart from the ground.

In accordance with a second aspect of the present invention, there is provided an image recognizing method including: acquiring a sample image having one or more target objects therein from a camera; calculating image locations and image heights for the respective target objects from the sample image to set a reference range of the image heights depending on the image positions; and determining whether a candidate area of each of target objects in the sample image acquired by the camera falls within the reference range to select an effective candidate area.

Further, said acquiring a sample image may comprise acquiring a plurality of sample images depending on the distance between the camera and the respective target objects.

Further, said setting a reference range may comprise: making a graph of the image heights depending on the image positions of the target objects; and approximating the upper bound and the lower bound of the image heights on the graph depending on the image locations in a straight line.

Further, the reference range may be the range between the lower bound and the upper bound.

Further, the image recognizing method may further comprise recognizing the target objects of an effective candidate area.

In accordance with the present invention, it is possible to detect the effective sizes of the target objects in the image and removing unnecessary candidate areas irrespective of the distance between the camera and the target objects, thereby requiring no complex calculation procedure and improving the image processing speed required for the detection of the target objects.

### BRIEF DESCRIPTION OF THE DRAWINGS

The above and other objects and features of the present invention will become apparent from the following description of the embodiments given in conjunction with the accompanying drawings, in which:

FIG. 1 is a view illustrating the problems occurring in a conventional image recognizing apparatus;

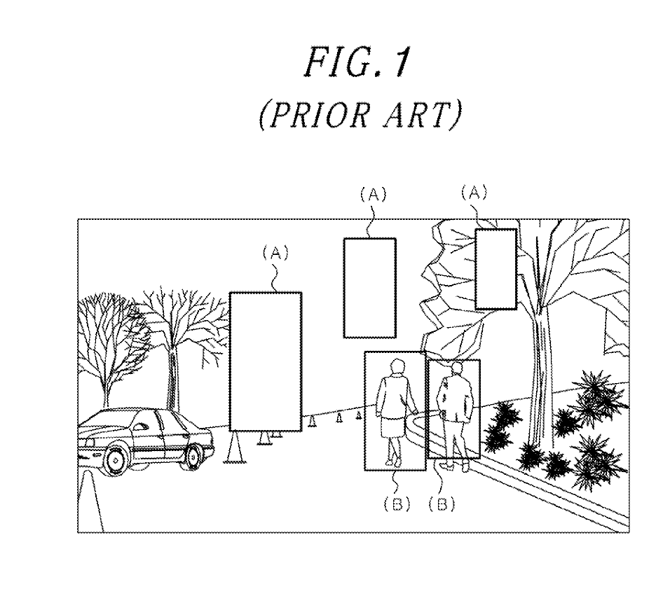

FIG. 2 is a view illustrating a conventional image recognizing method;

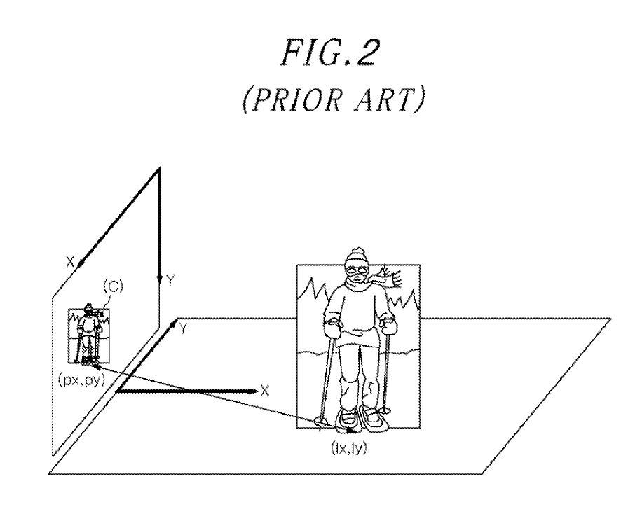

FIG. 3 is a block diagram of an image recognizing apparatus in accordance with an exemplary embodiment of the present invention;

FIG. 4 is a view of illustrating an image recognizing method in accordance with an exemplary embodiment of the present invention; and

FIG. 5 shows a graph illustrating an image height depending on an image location in accordance with an exemplary embodiment of the present invention.

### DETAILED DESCRIPTION OF THE EMBODIMENTS

Detailed description of the present invention will be described below with reference to the accompanying drawings illustrating specific embodiments of the present invention. These embodiments are described in detail so that those skilled in the art can easily practice the present invention. It should be understood that various embodiments of the present invention are different from each other, but need not be mutually exclusive. For example, a particular shape, structure and properties that are described herein and are related to one embodiment of the present invention may be implemented with other embodiments without departing the scope of the present invention. Further, it should be understood that the location and arrangement of the individual component in the embodiments may be changed without departing the scope of the present invention. Therefore, the detailed description below is rather than those that try to take as a limiting sense if it is explained properly, the scope of the present invention is only limited by all ranges identical to those that it claims, but the appended claims similar reference numerals refer to the same or similar elements throughout the drawings.

Hereinafter, the embodiments of the present invention will be described in detail with reference to the accompanying drawings which form a part hereof.

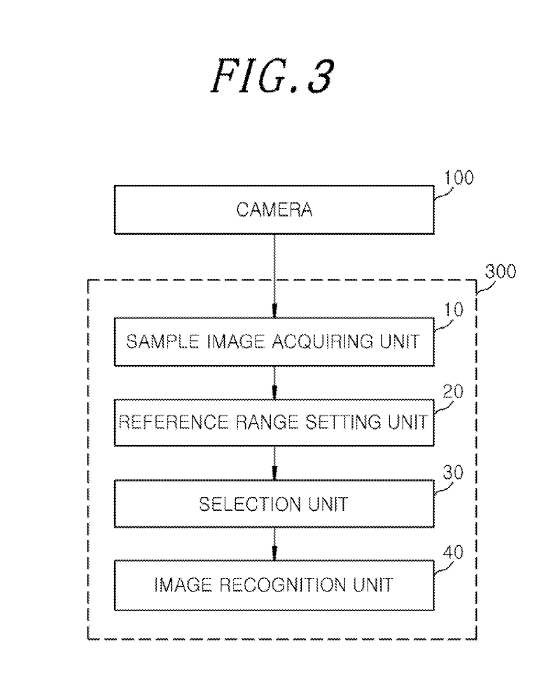

FIG. 3 is a block diagram of an image recognizing apparatus in accordance with an exemplary embodiment of the present invention.

Referring to FIG. 3, the image recognizing apparatus 300 includes a sample image acquiring unit 10, a reference range setting unit 20, an image selection unit 30, and an image recognition unit 40. The sample image acquiring unit acquires a sample image in which one or more target objects are included from a camera 100. In this regard, it is preferred that the sample image acquiring unit 10 is designed to acquire a plurality of sample images depending on the distance between the camera and the target objects. Moreover, it is preferable to arrange the camera 100 at a fixed location from the ground. For example, the sample images may include all the images acquired when the target objects approach the camera and the target objects become far away from the camera.

For example, the camera 100 may be a fixed CCTV camera installed on a structure such as a building, a camera fixedly attached on movable devices such as vehicles and robots, and the like.

The reference range setting unit 20 calculates the positions and heights (or size) of the target objects in the respective sample images and approximates the relationship of the positions and heights of the target objects in the image in a straight line. More specifically, the reference range setting unit 20 of the exemplary embodiment determines the upper bound and lower bound of the image heights depending on the image positions. The reference range setting unit 20 then defines an upper straight-line equation to approximate the upper bound of the image heights depending on the image positions of the target objects in a straight line and a lower straight-line equation to approximate the lower bound of the image heights depending on the image positions of the target objects in a straight line. Further, the reference range setting unit 20 defines a reference range as a range between the lower bound and upper bound of the image heights through the use of the upper straight-line equation and lower straight-line equation.

In this regard, the image position is defined as y-coordinate on the plane at which a target object comes in contact with the ground, that is, y-coordinate on the bottom of the target object. This is the reason that y-coordinates in the tops of the target objects fluctuate with the heights of the target objects, but y-coordinates in the bottoms of the target objects are determined by the distance between the camera 100 and the targets objects.

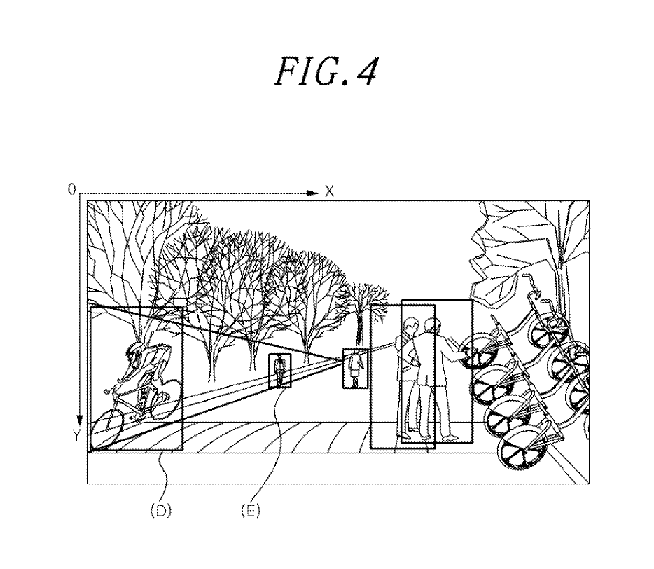

Image coordinate system as shown in FIG. 4 is represented by defining an origin as a left upper corner of the image, an x-axis in the direction of an increase from the origin to the right, and a y-axis in the direction of an increase in the downward direction from the origin. In addition, a rectangular box is used to represent a candidate area of a target object. In this case, the image position and the image height of the target object, e.g., pedestrian, on the ground has a linear relationship according to the distance between the camera 100 and the pedestrian.

That is, as shown in FIG. 4, the image location is placed in a downward direction in the image as the target object D is closer to the camera; and the image location is placed in an upward direction in the image as the image position of the target object E is farther from the camera. In addition, as the target object is closer to the camera, the larger the image height of the target objects. In this case, since the height or stature of the pedestrian has a constant value, the image heights of the pedestrians can be calculated depending on the image positions of the pedestrians. This can be expressed as in Equation 2.

h=ay+b [Equation 2]

where h denotes the image height of the target object; y denotes an image location of the target object; and a and b represent a constant.

The selection unit 30 calculates the upper and lower bounds of the image heights depending on the image locations of the target objects contained in the candidate areas in the sample image acquired by the camera 100 through the use of the upper and lower straight-line equations. The selection unit 30 determines whether each of the image heights of the candidate areas falls within the reference range. As a determination result, when the image height of the candidate area under consideration falls within the reference range, the selection unit 30 determines and selects the candidate area under consideration as an effective candidate area. Meanwhile, as the determination result, when the image height of the candidate area under consideration does not fall within the reference range, the selection unit 30 determines the candidate area under consideration as a useless candidate area and skips over same.

The image recognition unit 40 recognizes the target object(s) of the candidate area(s) selected by the selection unit 30.

Hereinafter, an image recognizing method will be described in accordance with an exemplary embodiment of the present invention. By way of example, the description will be made on the image recognizing method performed in the image recognizing apparatus 300 for detecting pedestrians in an image captured by a camera mounted in a vehicle.

First, the sample image acquiring unit 10 acquires a sample image including the pedestrians via the camera. In this case, it is preferable to acquire a plurality of sample images having different distances between the camera and the pedestrians.

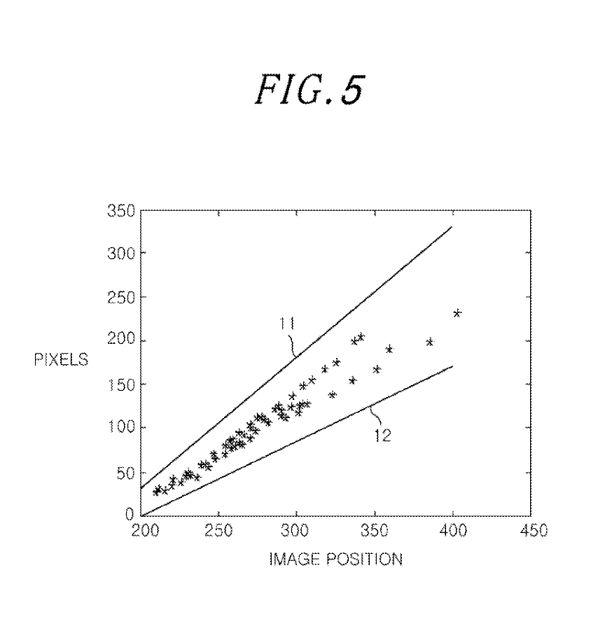

Next, the sample image acquiring unit 10 puts the image positions of the pedestrians, i.e., y-coordinates at tiptoe centers of the pedestrians and the image heights into the coordinate values (which are denoted by an asterisk (*)) on the graph. In the graph, the horizontal axis represents the image locations, and the vertical axis represents the image heights. FIG. 5 shows a graph which is plotted with respect to 57 sample images, and as known from the graph, the image position and the image heights have a linear relationship.

Subsequently, the reference range setting unit 20 approximates the image heights depending on the image positions in a straight line using the graph having a relationship between the image position and the image height to define an upper straight-line equation I1 and a lower straight-line equation I2. In this regard, a user may directly observe the graph so that the user determines the upper bound and lower bound of the image heights from the graph in consideration of height deviation, i.e., the recognition error of the camera and the height difference between adults and children. Otherwise, the upper bound and lower bound of the image heights may be automatically calculated using a prescribed equation. The upper straight-line equation I1 and the lower straight-line equation I2 are expressed as flowing Equation 3.

[Equation 3]

h=a₁y+b₁ I1:

h=a₂y+b₂ I2:

Now, it is assumed that the image location of a candidate area in the sample image is y′ and the image height of the candidate area is h′. The lower straight-line equation of the image height of the pedestrian at the image position y′ becomes a₂y′+b₂ and the upper straight-line equation becomes a₁y′+b₁. The selection unit 30 then determines whether the image height h′ is satisfied by an inequality of a₂y′+b₂≦h′≦a₁y′+b₁In this case, the range of the inequality becomes the reference range. As a determination result, when the image height h′ satisfies the reference range, the selection unit 30 determines that the candidate area having the image height h′ is the effective candidate area. However, when the image height h′ does not satisfy the reference range, the selection unit 30 determines that the candidate area having the image height h′ is the useless candidate area and skips over same. Thereafter, the image recognition unit 40 tries to recognize the target objects of the effective candidate areas.

As described above, the image recognizing and method of the exemplary embodiment of the present invention is capable of detecting the effective sizes of the target objects in the image and removing unnecessary candidate areas irrespective of the distance between the camera and the target objects, thereby requiring no complex calculation procedure and improving the image processing speed required for the detection of the target objects.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An image recognizing apparatus comprising:
a sample image acquiring unit configured to acquire a sample image having one or more target objects therein from a camera; a reference range setting unit configured to calculate image locations and image heights for the respective target objects from the sample image and set a reference range of the image heights depending on the image positions; and
a selection unit configured to determine whether a candidate area of each target object in the sample image acquired by the camera falls within the reference range to select an effective candidate area.

2. The image recognizing apparatus of claim 1, wherein the sample image acquiring unit acquires a plurality of sample images depending on the distance between the camera and the respective target objects.

3. The image recognizing apparatus of claim 1, wherein the reference range setting unit makes a graph of the image heights depending on the image positions of the target objects and approximates the upper bound and the lower bound of the image heights on the graph depending on the image locations in a straight line.

4. The image recognizing apparatus of claim 3, wherein the reference range is the range between the lower bound and the upper bound.

5. The image recognizing apparatus of claim 3, wherein the upper bound and the lower bound of the image heights are set by a user.

6. The image recognizing apparatus of claim 1, further comprising an image recognition unit configured to recognize the target object in the effective candidate area.

7. The image recognizing apparatus of claim 1, wherein the camera is placed in a fixed location spaced apart from the ground.

8. An image recognizing method comprising:
acquiring a sample image having one or more target objects therein from a camera;
calculating image locations and image heights for the respective target objects from the sample image to set a reference range of the image heights depending on the image positions; and
determining whether a candidate area of each of target objects in the sample image acquired by the camera falls within the reference range to select an effective candidate area.

9. The image recognizing method of claim 8, wherein said acquiring a sample image comprises acquiring a plurality of sample images depending on the distance between the camera and the respective target objects.

10. The image recognizing method of claim 8, wherein said setting a reference range comprises:
making a graph of the image heights depending on the image positions of the target objects; and
approximating the upper bound and the lower bound of the image heights on the graph depending on the image locations in a straight line.

11. The image recognizing method of claim 10, wherein the reference range is the range between the lower bound and the upper bound.

12. The image recognizing method of claim 8, further comprising recognizing the target objects of an effective candidate area.
